(19) United States
(12) Patent Application Publication
(10) Pub. No.: US 2015/0242335 A1
(43) Pub. Date: Aug. 27, 2015

(54) METHOD OF OPERATING STORAGE DEVICE INCLUDING NONVOLATILE MEMORY AND MEMORY CONTROLLER

(71) Applicant: SAMSUNG ELECTRONICS CO., LTD., Suwon-si (KR)

(72) Inventors: HEESOO KIM, HWASEONG-SI (KR); JISOO KIM, YONGIN-SI (KR)

(21) Appl. No.: 14/600,121

(22) Filed: Jan. 20, 2015

(30) Foreign Application Priority Data
Feb. 26, 2014 (KR) 10-2014-0022682

(51) Int. Cl. G06F 12/14

(52) U.S. Cl. CPC G06F 12/1433

(57) ABSTRACT

Provided is a method for operating a storage device including a nonvolatile memory and a memory controller controlling the nonvolatile memory. The method include receiving a kill request by the memory controller, performing authentication based on the received kill request by the memory controller, and entering a locked state, by the memory controller, according to the kill request when the authentication is successfully performed. In the locked state, the memory controller denies a request for access to a selected area of the nonvolatile memory.

### CROSS-REFERENCE TO RELATED APPLICATIONS

This US non-provisional patent application claims priority under 35 USC §119 to Korean Patent Application No. 10-2014-0022682, filed on Feb. 26, 2014, the entirety of which is hereby incorporated by reference.

### BACKGROUND OF THE INVENTION

Embodiments of the present disclosure relate to semiconductor memory devices and, more particularly, to methods of operating a storage device including a nonvolatile memory and a memory controller.

Semiconductor memory device are memory devices implemented using semiconductors such as silicon (Si), germanium (Ge), gallium arsenide (GaAs), and indium phosphide (InP). In general, semiconductor memory devices are classified into volatile memory devices and nonvolatile memory devices.

Volatile memory devices lose their stored data when their power supplies are interrupted. Volatile memory devices include a static RAM (SRAM), a dynamic RAM (DRAM), a synchronous DRAM (SDRAM), and the like. Nonvolatile memory devices retain their stored data even when their power supplies are interrupted. Nonvolatile memory devices include a read only memory (ROM), a programmable ROM (PROM), an electrically programmable ROM (EPROM), an electrically erasable and programmable ROM (EEPROM), a flash memory, a phase-change RAM (PRAM), a resistive RAM (RRAM), a ferroelectric RAM (FRAM), and the like.

A nonvolatile memory is used as a storage of a mobile device such as a smartphone, a smart pad or the like. As the range of use of mobile devices is extended, sensitive personal information has been stored in a nonvolatile memory for use in a mobile device. Personal information stored in a nonvolatile memory may be leaked to the public when a mobile device is lost.

### SUMMARY OF THE INVENTION

Embodiments of the disclosure provide methods for operating a storage device including a nonvolatile memory and a memory controller to control the nonvolatile memory.

The method according to some embodiments may include receiving a kill request by the memory controller; performing authentication based on the received kill request by the memory controller; and entering a locked state, by the memory controller, according to the kill request when the authentication is successfully performed. In the locked state, the memory controller denies a request for access to a selected area of the nonvolatile memory.

In an exemplary embodiment, the selected area may include a whole area of the nonvolatile memory.

In an exemplary embodiment, the selected area may include a partial area of a whole area of the nonvolatile memory.

In an exemplary embodiment, when the received kill request is a first type, the selected area may include a whole area of the nonvolatile memory. When the received kill request is a second type, the selected area may include a partial area of the whole area of the nonvolatile memory.

In an exemplary embodiment, the method may further include receiving a revive request; performing second authentication based on the received revive request; and entering a normal state, by the memory controller, according to the revive request when the second authentication is successfully performed. In the normal state, the memory controller allows a request for access to the nonvolatile memory.

In an exemplary embodiment, the nonvolatile memory and the memory controller may constitute an embedded storage module.

In an exemplary embodiment, the nonvolatile memory and the memory controller may constitute a solid-state drive (SSD).

In an exemplary embodiment, the nonvolatile memory and the memory controller may constitute a storage module of a mobile device.

The method according to other embodiments may include receiving a kill request by the memory controller; performing authentication based on the received kill request by the memory controller; and destroing data in a selected area among data stored in the nonvolatile memory, by the memory controller, according to the kill request when the authentication is successfully performed.

In an exemplary embodiment, the data in the selected area may be erased when the memory controller destroys the data in the selected area.

In an exemplary embodiment, the data in the selected data may be overwritten as predetermined pattern data or random pattern data when the memory controller destroys the data in the selected area.

In an exemplary embodiment, a key data used to encode or decode the data in the selected area may be erased when the memory controller destroys the data in the selected area.

In an exemplary embodiment, the selected area may include a whole area of the nonvolatile memory.

In an exemplary embodiment, the selected area may include a partial area among a whole area of the nonvolatile memory.

In an exemplary embodiment, when the received kill request is a first type, the selected area may include a whole area of the nonvolatile memory. When the received kill request is a second type, the selected area may include a partial area of the whole area of the nonvolatile memory.

In an exemplary embodiment, the method may further include entering a locked state, by the memory controller, after destroying the data in the selected area. The memory controller denies a request for access to the nonvolatile memory in the locked state.

In an exemplary embodiment, the method may further include receiving a revive request by the memory controller; performing second authentication based on the received revive request by the memory controller; and entering a normal state, by the memory controller, according to the revive request when the second authentication is successfully performed. The memory controller allows a request for access to the nonvolatile memory in the normal state.

The method according to another embodiments may include receiving a kill request by the memory controller; performing authentication based on the received kill request by the memory controller; entering a locked mode, by the memory controller, when the authentication is successful and the received kill request is a first type; and entering a destruction mode, by the memory controller, when the authentication is successful and the received kill request is a second type. The memory controller denies a request for access to a selected area of the nonvolatile memory in the locked mode. The memory controller destroys data in the selected area among data stored in the nonvolatile memory in the destruction mode.

In an exemplary embodiment, the method further includes entering the locked mode, by the memory controller, after destroying the data in the destruction mode.

In an exemplary embodiment, the selected area is a whole area of the nonvolatile memory when the received kill request is a global request. The selected area is a partial area of the whole area of the nonvolatile memory when the received kill request is a partial request

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain principles of the disclosure. In the drawings:

FIG. 1 is a conceptual diagram of a kill system according to an embodiment of the inventive concept;

FIG. 2 is a block diagram of a mobile device according to an embodiment of the inventive concept;

FIG. 3 is a flowchart summarizing the steps of triggering a kill function according to an embodiment of the inventive concept;

FIG. 4 is a block diagram of a storage according to an embodiment of the inventive concept;

FIG. 5 is a flowchart summarizing a method of performing a kill function according to an embodiment of the inventive concept;

FIG. 6 is a flowchart summarizing a method of performing a kill function according to another embodiment of the inventive concept;

FIG. 7 is a flowchart summarizing a method of performing a kill function according to another embodiment of the inventive concept;

FIG. 8 is a flowchart summarizing a method of performing a kill function according to another embodiment of the inventive concept;

FIG. 9 is a flowchart summarizing a method of performing a kill function according to another embodiment of the inventive concept;

FIG. 10 is a block diagram of a nonvolatile memory according to an embodiment of the inventive concept;

FIG. 11 is a circuit diagram of a memory block according to an embodiment of the inventive concept;

FIG. 12 is a circuit diagram of a memory block according to another embodiment of the inventive concept;

FIG. 13 is a block diagram of a memory controller according to an embodiment of the inventive concept;

FIG. 14 is a block diagram of a storage according to another embodiment of the inventive concept;

FIG. 15 is a block diagram of a storage according to another embodiment of the inventive concept; and

FIG. 16 is a block diagram of a mobile device according to another embodiment of the inventive concept.

### DETAILED DESCRIPTION

Exemplary embodiments in accordance with the inventive concept will now be described more fully hereinafter with reference to the accompanying drawings.

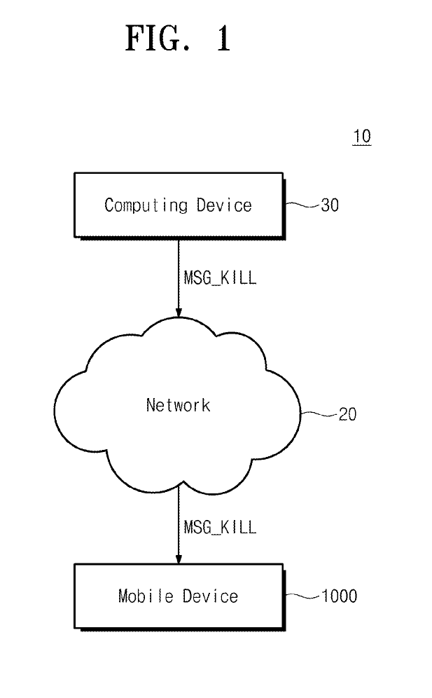

FIG. 1 is a conceptual diagram of a kill system 10 according to an embodiment of the inventive concept. As illustrated, the kill system 10 includes a network 20, a computing device 30, and a mobile device 1000.

The network 20 provides a communication channel between the computing device 30 and the mobile device 1000. The network 20 may include the Internet. The network 20 may include a wireless communication network of the mobile device 1000 such as an LTE network.

The computing device 30 may communicate with the network 20. The computing device 30 may include a personal computer (PC), a notebook computer, a laptop computer, a smartphone, a smart pad, and the like.

When the mobile device 1000 is lost, data stored in the mobile device 1000 may be leaked or hacked. The mobile device 1000 may support a kill function to prevent leakage or hacking of the data stored in the mobile device 1000.

For example, when the mobile device 1000 is lost, a user of the mobile device 1000 may transmit a kill message MSG_KILL through the network 20 using the computing device 30. The user may transmit the kill message MSG_KILL together with predetermined authentication information such as a password.

In response to the kill message MSG_KILL, the mobile device 1000 may deny a request for access to the stored data. That is, the mobile device 1000 may prevent leakage or hacking of the stored data by using the kill message MSG_KILL.

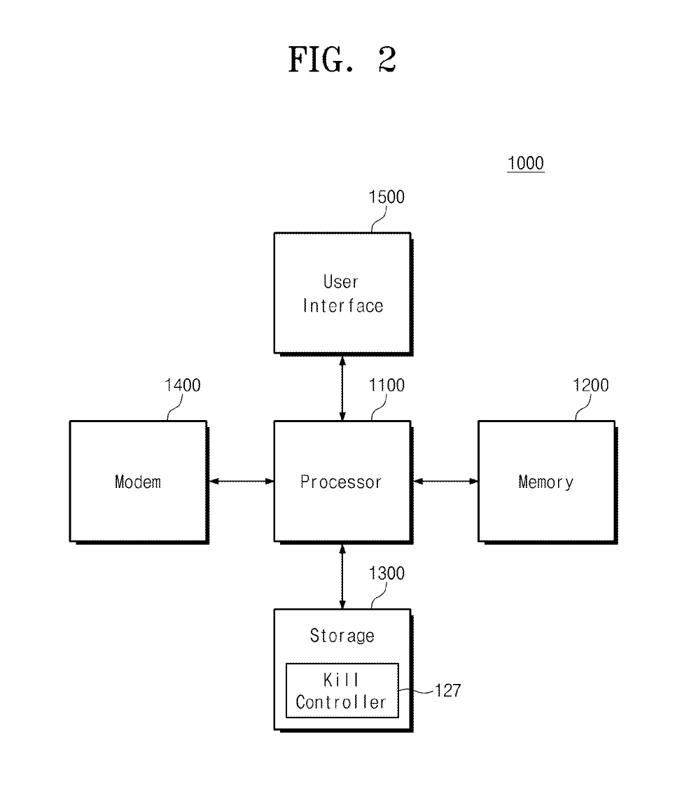

FIG. 2 is a block diagram of a mobile device 1000 according to an embodiment of the inventive concept. Referring to FIGS. 1 and 2, the mobile device 1000 includes a processor 1100, a memory 1200, a storage 1300, a modem 1400, and a user interface 1500.

The processor 1100 may control the overall operation of the mobile device 1000 and perform a logical operation. For example, the processor 1100 may include a system-on-chip (SoC). The processor 1100 may be an application processor.

The memory 1200 may communicate with the processor 1100. The memory 1200 may be a main memory of the processor 1100 or the mobile device 1000. The processor 1100 may temporarily store a code or data in the memory 1200. The processor 1100 may execute a code and process data using the memory 130. The processor 1100 may execute various types of software such as an operating system (OS) and an application. The processor 1100 may control the overall operation of the mobile device 1000 using the memory 1200. The memory 1200 may include a volatile memory such as a static RAM (SRAM), a dynamic RAM (DRAM), and a synchronous DRAM (SDRAM) or a nonvolatile memory such as a phase-change RAM (PRAM), a magnetic RAM (MRAM), a resistive RAM (RRAM), and a ferroelectric RAM (FRAM). The memory 1200 may include a random access memory (RAM).

The storage 1300 may communicate with the processor 1100. The storage may store data that must be reserved in the long term. That is, the processor 1100 may store data, which must be reserved in the long term, in the storage 1300. The storage 1300 may store a boot image to drive the mobile device 1000. The storage 1300 may store source codes of various types of software such as an operating system (OS) and an application. The storage 1300 may store data processed by various types of software such as an operating system (OS) and an application.

In some embodiments, the processor 1100 may load the source codes stored in the storage 1300 to the memory 1200 and execute the codes loaded to the memory 1200 to drive various types of software such as an operating system (OS) and an application. The processor 1100 may load data stored in the storage 1300 to the memory 1200 and process the data loaded to the memory 1200. The processor 1100 may store data, which is desired to be reserved in the long term among the data stored in the memory 1200, in the storage 1300.

The storage 1300 may include a nonvolatile memory such as a flash memory, a phase-change RAM (PRAM), a magnetic RAM (MRAM), a resistive RAM (RRAM), and a ferroelectric RAM (FRAM).

The storage 1300 may include a kill controller 127. The kill controller may receive a kill request and perform a kill function in response to the received kill request. The kill function may include an operation of denying a request for access to data stored in the storage 1300.

The modem 1400 may communicate with an external device (e.g., computing device 30) according to the control of the processor 1100. For example, the modem 1400 may perform wired or wireless communication with the external device. The modem 1400 may perform communication based on at least one of various wireless communication schemes such as long term evolution (LTE), WiMax, global system for mobile communication (GSM), (code division multiple access (CDMA), Bluetooth, (near field communication (NFC), WiFi, and radio frequency identification (RFID) or at least one of various wired communication schemes such as universal serial bus (USB), serial AT attachment (SATA), small computer system interface (SCSI), serial attached SCSI (SAS), Firewire, peripheral component interconnection (PCI), PCI express, and nonvolatile memory express (NVMe).

The user interface 1500 may communicate with a user according to the control of the processor 1100. For example, the user interface 1500 may include user input interfaces such as a keyboard, a keypad, a button, a touch panel, a touch screen, a touch pad, a touch ball, a camera, a microphone, a gyroscope sensor, and a vibration sensor. The user interface 1500 may include user output interfaces such as a liquid crystal display (LCD), an organic light emitting diode (OLED) display, an active matrix OLED (AMOLED), an LED, a speaker, and a monitor.

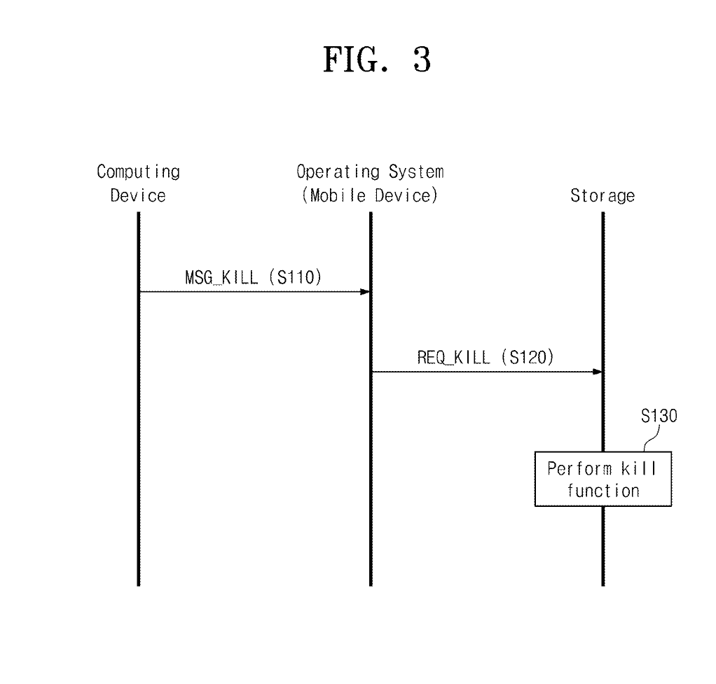

FIG. 3 is a flowchart summarizing the steps of triggering a kill function according to an embodiment of the inventive concept. Referring to FIGS. 1 to 3, when the mobile device 1000 is lost, a kill message MSG_KILL may be transmitted using the computing device 30 connected to the network 20 (S110). The kill message MSG_KILL may be transmitted to the mobile device 1000 through the network 20.

The mobile device 1000 may receive the kill message MSG_KILL using the modem 1400. When the kill message MSG_KILL is received, an operating system of the mobile device 1000 may transmit a kill request REQ_KILL to the storage 1300 (S120).

When the kill request REQ_KILL is received, the storage 1300 may perform a kill function (S130).

Conventionally, a kill function applied to the mobile device 1000 has been supported by an application, an operating system or firmware of the mobile device 1000. In this case, the kill function may be executed on the processor 1100 and the memory 1200, and the kill function may become a target of hacking. That is, the kill function may be intercepted by hacking. If the kill function is hacked, user's personal information is leaked. In addition, if the storage 1300 is removed from the mobile device 1000, personal information stored in the storage 1300 may be leaked because the access to the data is denied by the application, the operating system of the firmware of the mobile device not the storage 1300.

Meanwhile, according to embodiments of the inventive concept, the kill function is supported by the storage 1300. The mobile device 1000 may perform only a function to transmit the kill request REQ_KILL to the storage 1300 in response to an externally received kill message MSG_KILL. When the kill function is executed in the storage 1300, the kill function is prevented from being hacked because the kill function is performed not using the memory 1200 and the processor 1100. In addition, when the storage 1300 is removed from the mobile device 1000, personal information stored in the storage 1300 is prevented from being leaked because the storage 1300 itself denies the access to the data.

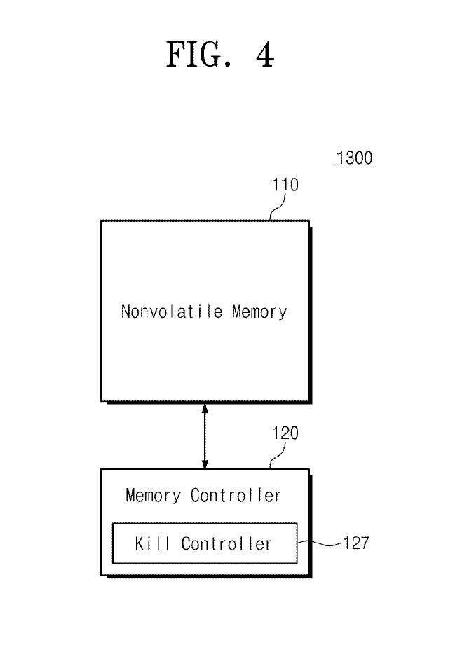

FIG. 4 is a block diagram of a storage 1300 according to an embodiment of the inventive concept. As illustrated, the storage 1300 includes a nonvolatile memory 110 and a memory controller 120.

The nonvolatile memory 110 is configured to perform write, read, and erase operations according to the control of the memory controller 120. The nonvolatile memory 110 may include a flash memory, a phase-change RAM (PRAM), a magnetic RAM (MRAM), a resistive RAM (RRAM), a ferroelectric RAM (FRAM) or the like.

The memory controller 120 is configured to control the nonvolatile memory 110. The memory controller 120 may control the write, read or erase operation of the nonvolatile memory 110 according to a request of an external device (e.g., the processor 1100 in FIG. 2) or according to an internally determined schedule.

The memory controller 120 includes a kill controller 127. The kill controller 127 may perform a kill function in response to an externally received kill request REQ_KILL. The kill function may be a function of denying a request for access to all or some of the data stored in the nonvolatile memory 110.

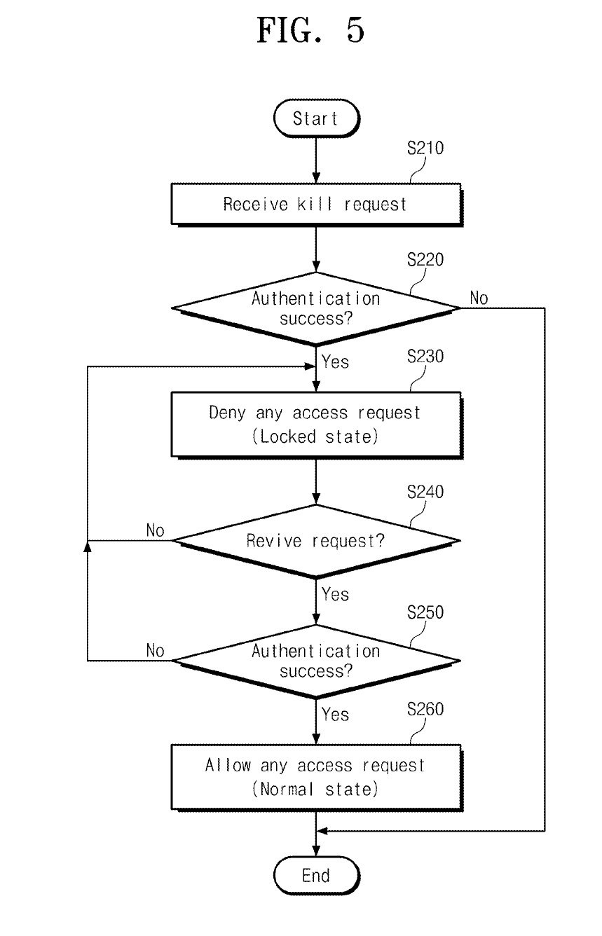

FIG. 5 is a flowchart summarizing a method of performing a kill function according to an embodiment of the inventive concept. Referring to FIGS. 4 and 5, a kill request is received (S210). For example, as explained with reference to FIGS. 1 to 3, the processor 1100 may transmit a kill request REQ_KILL to the memory controller 120 in response to a kill message MSG_KILL transmitted from the computing device 30. The kill request REQ_KILL may include authentication information for performing authentication. When the kill request REQ_KILL is received, the kill controller 127 may perform a subsequent operation described below.

Authentication is performed based on the kill request REQ_KILL (S220). The authentication may be performed by the kill controller 127 or may be performed by a separate authentication module according to the control of the kill controller 127. When the authentication is failed, the kill function is stopped and ended. When the authentication is successfully performed, the flow proceeds to S230.

The memory controller 120 enters a locked state (S230). In the locked state, the memory controller 120 may deny a request for access to the nonvolatile memory 110 that is received from an external device. For example, the memory controller 120 may deny a read request, a write request or both the read request and the write request received from the external device.

Determination is made as to whether a revive request is received (S240). When the revive request is not received, the memory controller 120 may be maintained in the locked state. When the revive request is received, the flow proceeds to S250. The revive request may include authentication information for performing authentication such as a predetermined password. The authentication of the revive request may be different from the authentication information of the kill request.

Authentication is performed based on the revive request (S250). The authentication may be performed by the kill controller 127 or may be performed by a separate authentication module according to the control of the kill controller 127. When the authentication is failed, the memory controller 120 is maintained in the locked state. If the authentication is successfully performed, the flow proceeds to S260.

The memory controller 120 enters a normal state (S260). In the normal state, the memory controller 120 may allow a request for access to the nonvolatile memory 110. For example, the memory controller 120 may perform a read operation, a write operation or the read and write operations in response to a read request, a write request or the read and write requests from an external device.

As explained above, in response to a kill request, the memory controller 120 enters a looked state to deny access of an external device. Thus, personal information stored in the nonvolatile memory 110 may be prevented from being leaked. In response to a revive request, the memory controller 120 enters a normal state to allow the access of the external device. That is, if necessary, the personal information stored in the nonvolatile memory 110 may be reused.

In some embodiments, a kill request and a revive request may be defined as a Vendor command. The Vendor command may be an additional command supported by a manufacturer and not defined by a specification for normal commands. In other embodiments, a kill request and a revive request may be defined as a combination of normal commands such as read, write, and erase commands. A method of receiving a kill request and a revive request by the storage 1300 may be variously applied and is not limited to the above description.

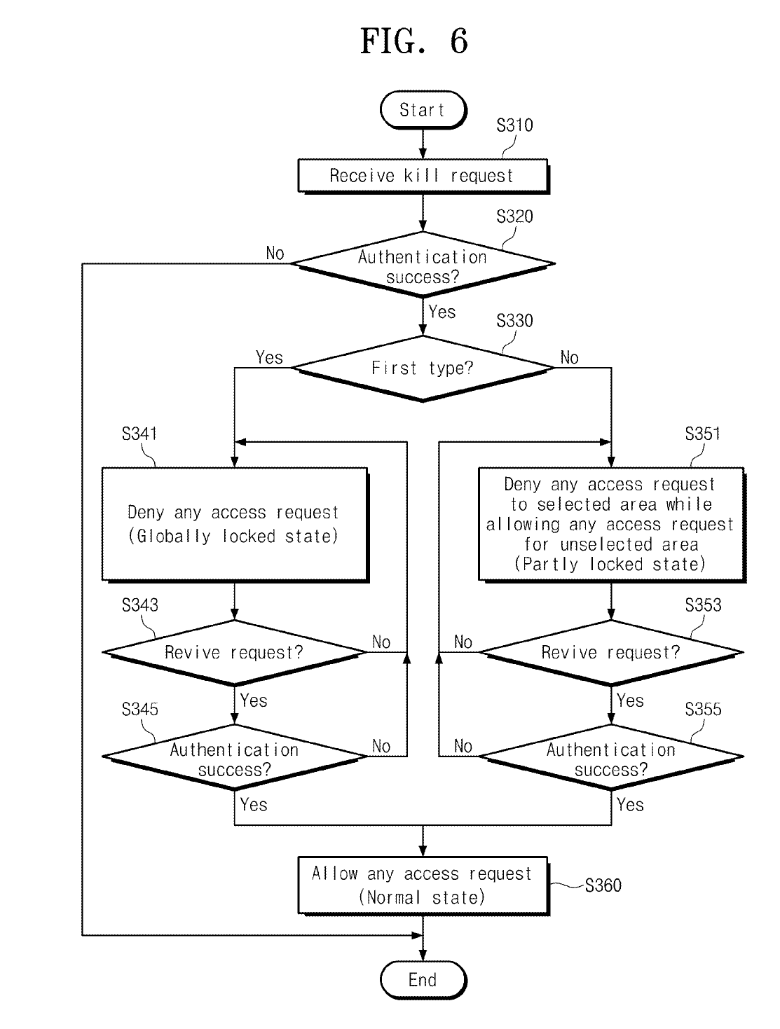

FIG. 6 is a flowchart summarizing a method of performing a kill function according to another embodiment of the inventive concept. Referring to FIGS. 4 and 6, a kill request is received (S310). Authentication is performed based on the kill request (S320). When the authentication is failed, the kill function is stopped and ended. When the authentication is successfully performed, the flow proceeds to S330.

Determination is made as to whether the kill request is a first type (S330). For example, the kill request may have a first type and a second type. When the kill request is the first type, the flow proceeds to S341. When the kill request is the second type, the flow proceeds to S351.

When the kill request is the first type, the memory controller 120 enters a globally locked state (S341). In the globally locked state, the memory controller 120 may deny a request for access to a whole area of the nonvolatile memory 110. Determination is made as to whether a revive request is received (S343). When the revive request is not received, the globally locked state is maintained. When the revive request is received, authentication is performed (S345). When the authentication is failed, the globally locked state is maintained. When the authentication is successfully performed, the memory controller 120 enters a normal state (S360).

When the kill request is the second type, the memory controller 120 enters a partly locked state (S351). In the partly locked state, the memory controller 120 may deny a request for access to a selected area of the nonvolatile memory 110 and allow a request for access to an unselected area of the nonvolatile memory 110. For example, the selected area may be an area in which user's personal information is stored and may be defined in advance by the user. The unselected area may be an area in which general data of low importance and low sensitivity is stored. That is, in the partly locked state, a request for access to important data such as personal information may be denied while a request for access to general data may be allowed. Determination is made as to whether a revive request is received (S353). When the revive request is not received, the partly locked state is maintained. When the revive request is received, authentication is performed (S355). When the authentication is failed, the globally locked state is maintained. When the authentication is successfully performed, the memory controller 120 enters a normal state (S360).

As explained above, in response to a kill request, the memory controller 120 may enter a globally locked state in which a request for access to a whole area of the nonvolatile memory 110 is denied or a partly locked state in which a request for access to a partial area of the nonvolatile memory 110 is denied. In response to a revive request, the memory controller 120 enters a normal state in which access of an external device is allowed. Thus, personal information stored in the nonvolatile memory 110 may be prevented from being leaked and may be reused, if necessary.

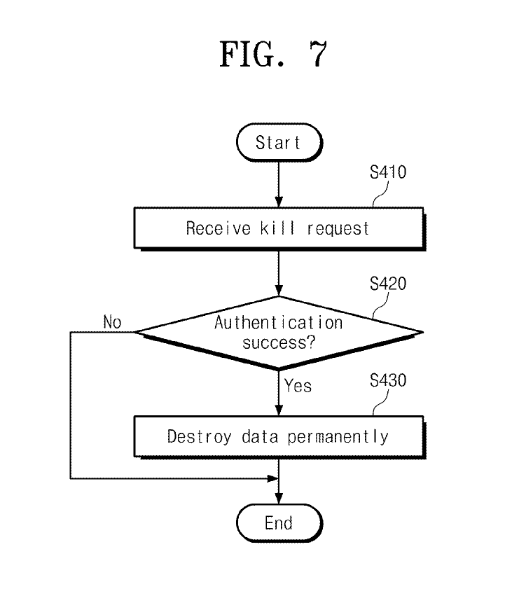

FIG. 7 is a flowchart summarizing a method of performing a kill function according to another embodiment of the inventive concept. Referring to FIGS. 4 and 7, a kill request is received (S410). Authentication is performed based on the kill request (S420). When the authentication is failed, the kill function is stopped and ended. When the authentication is successfully performed, the flow proceeds to S430.

The memory controller 120 may permanently destroy data stored in the nonvolatile memory 110 according to the control of the kill controller 127 (S430). For example, the memory controller 120 may erase the whole area of the nonvolatile memory 110. The memory controller 120 may overwrite predetermined pattern data or random data into the whole area of the nonvolatile memory 110. For example, the memory controller 120 may erase the whole area of the nonvolatile memory 110 and write predetermined pattern data or random data. For example, the memory controller 120 may erase a key used when data read from the nonvolatile memory 110 is decoded.

In some embodiments, the memory controller 120 may encode data and write the encoded data into the nonvolatile memory 110. The memory controller 120 may decode data read from the nonvolatile memory 110. When the encoding and decoding are performed, the memory controller 120 may use a key. The key may be stored in the nonvolatile memory 110 together with the encoded data. When the key stored in the nonvolatile memory 110 is erased, data read from the nonvolatile memory 110 cannot be decoded. When the decoding cannot be performed, original data cannot be obtained from the decoded data. Thus, the data stored in the nonvolatile memory 110 may be permanently destroyed by erasing the key.

In some embodiments, the memory controller 120 may erase a key for use in encryption and decryption. In some embodiments, the memory controller 120 may erase a key for use in randomization and derandomization.

As explained above, in response to a kill request, the memory controller 120 may permanently destroy data stored in the nonvolatile memory 110. Thus, personal information stored in the nonvolatile memory 110 may be prevented from being leaked.

In some embodiments, after data stored in the nonvolatile memory 110 is destroyed, the memory controller 120 may further deny a request for access to the nonvolatile memory 110. For example, the memory controller 120 may enter a locked state, as explained with reference to FIG. 5 or 6. Then, the memory controller may enter a normal state in response to a revive request.

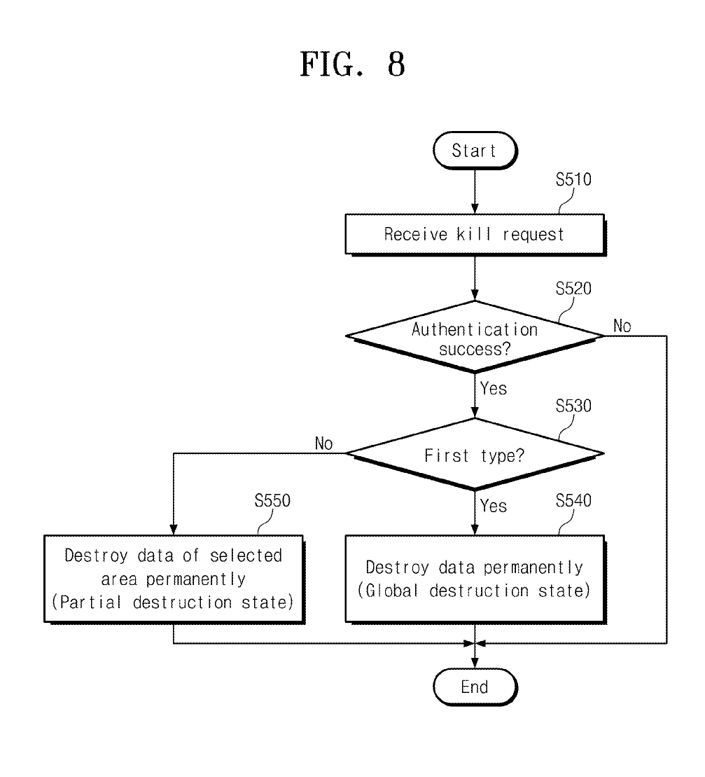

FIG. 8 is a flowchart summarizing a method of performing a kill function according to another embodiment of the inventive concept. Referring to FIGS. 4 and 8, a kill request is received (S510). Authentication is performed based on the kill request (S520). When the authentication is failed, the kill function is stopped and ended. When the authentication is successfully performed, the flow proceeds to S530.

Determination is made as to whether the kill request is a first type (S530). For example, the kill request may have a first type or a second type that is different from the first type.

When the kill request is the first type, the memory controller 120 may enter a global destruction state (S540). In the global destruction state, the memory controller 120 may destroy all data stored in the nonvolatile memory 110.

When the kill request is the second type, the memory controller 120 enters a partial destruction state (S550). In the partial destruction state, the memory controller 120 may destroy data of a selected area of the nonvolatile memory 110. For example, the selected area may be an area in which user's personal information is stored and may be defined in advance by the user. The unselected area may be an area in which general data of low importance and low sensitivity is stored.

As explained above, in response to a kill request, the memory controller 120 may globally or selectively destroy data stored in the nonvolatile memory 110. Thus, personal information stored in the nonvolatile memory 110 may be prevented from being leaked or hacked.

In some embodiments, after data stored in the nonvolatile memory 110 is destroyed, the memory controller 120 may further deny a request for global or partial access to the nonvolatile memory 110. For example, the memory controller 120 may enter a locked state, as explained with reference to FIG. 5 or 6. Then, the memory controller enter a normal state in response to a revive request.

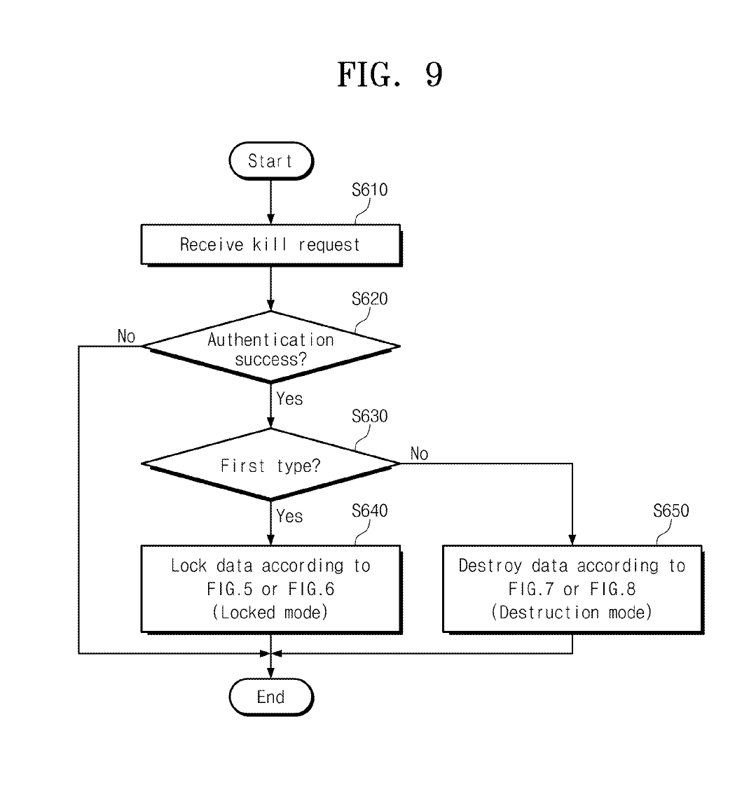

FIG. 9 is a flowchart summarizing a method of performing a kill function according to another embodiment of the inventive concept. Referring to FIGS. 4 and 9, a kill request is received (S610). Authentication is performed based on the kill request (S520). When the authentication is failed, the kill function is stopped and ended. When the authentication is successfully performed, the flow proceeds to S630.

Determination is made as to whether the kill request is a first type (S630). For example, the kill request may have a first type or a second type that is different from the first type.

When the kill request is the first type, the memory controller 120 may enter a locked mode (S640). In the locked mode, the memory controller 120 may lock all or some of data stored in the nonvolatile memory 110, as explained with reference to FIG. 5 or 6. In addition, the memory controller 120 may unlock the nonvolatile memory 110 in response to a revive request.

When the kill request is the second type, the memory controller 120 may enter a destruction mode (S650). In the destruction mode, the memory controller 120 may destroy all or some of data stored in the nonvolatile memory 110, as explained with reference to FIG. 7 or 8. After that, the memory controller 120 may globally or partially lock the nonvolatile memory 110. Then, the memory controller may unlock the nonvolatile memory in response to a revive request.

As explained above, in response to a kill request, the memory controller 120 may selectively lock or destroy data stored in the nonvolatile memory 110. Thus, an optimal scheme may be provided to prevent leakage of personal information according to a user's need or situation.

In some embodiments, when the kill function is performed, some of read, write, and erase operations on the nonvolatile memory 110 may be denied while the other operations may be allowed. For example, a read operation on the nonvolatile memory 110 may be denied while write and erase operation on the nonvolatile memory 110 may be allowed.

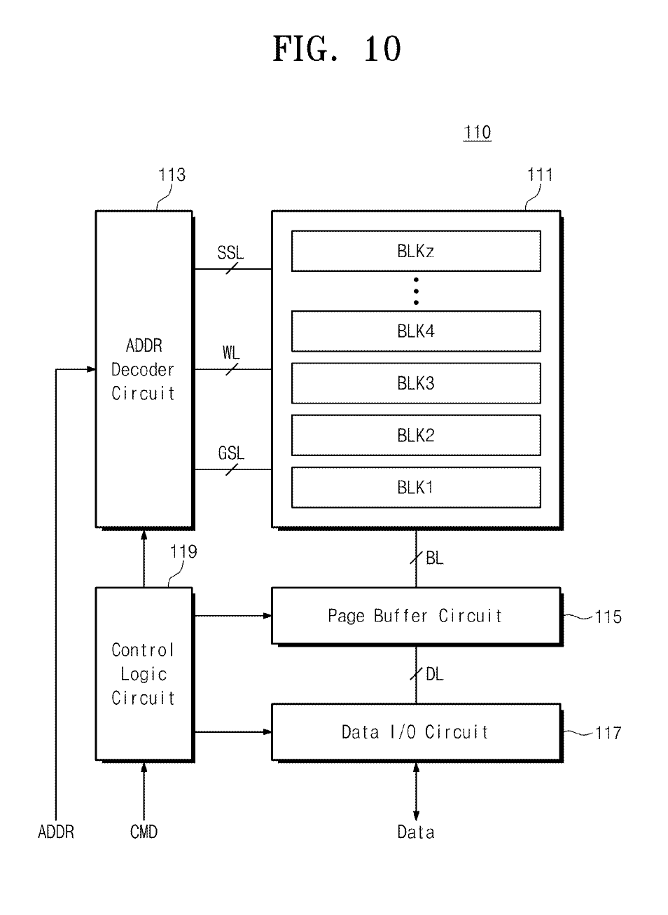

FIG. 10 is a block diagram of a nonvolatile memory 110 according to an embodiment of the inventive concept. As illustrated, the nonvolatile memory 110 includes a memory cell array 111, an address decoder circuit 113, a page buffer circuit 115, a data input/output (I/O) circuit 117, and a control logic circuit 119.

The memory cell array 111 includes a plurality of memory blocks BLK1 to BLKz. Each of the memory blocks BLK1 to BLKz includes a plurality of memory cells. Each of the memory blocks may be connected to the address decoder circuit 113 through at least one ground selection line GSL, a plurality of wordlines WL, and at least one of string selection line SSL. Each of the memory blocks may be connected to the page buffer circuit 115 through a plurality of bitlines BL. The memory blocks BLK1 to BLKz may be commonly connected to the bitlines BL. Memory cells of the memory blocks BLK1 to BLKz may have the same structure.

The address decoder circuit 113 is connected to the memory cell array 11 through a plurality of ground selection lines GSL, a plurality of wordlines WL, and a plurality of string selection lines SSL. The address decoder circuit 113 operates according to the control of the control logic circuit 119. The address decoder circuit 113 may receive an address ADDR from the memory controller 120. The address decoder circuit 113 may decode the received address ADDR and control voltage applied to the wordlines WL according to the decoded address.

The page buffer circuit 115 is connected to the memory cell array 111 through a plurality of bitlines BL. The page buffer circuit 115 is connected to the data I/O circuit 111 through a plurality of data lines DL. The page buffer circuit 115 operates according to the control of the control logic circuit 119.

The page buffer circuit 115 may store data to be programmed into memory cells of the memory cell array 111 or data read from the memory cells. During a program operation, the page buffer circuit 115 may store data to be programmed into memory cells. Based on the stored data, the page buffer circuit 115 may bias a plurality of bitlines BL. During the program operation, the page buffer circuit 115 may function as a write driver. During a read operation, the page buffer circuit 115 may sense voltages of the bitlines BL and store a sensing result. During the read operation, the page buffer circuit 115 may function as a sense amplifier.

The data I/O circuit 117 is connected to the page buffer circuit 115 through a plurality of data lines DL. The data I/O circuit 117 may exchange data DATA with the memory controller 120.

The data I/O circuit 117 may temporarily store data DATA received from the memory controller 120. The data I/O circuit 117 may transmit the stored data to the page buffer circuit 115. The data I/O circuit 117 may temporarily store the data DATA transmitted from the page buffer circuit 115. The data I/O circuit 117 may transmit the stored data DATA to an external device. The data I/O circuit 117 may function as a buffer memory.

The control logic circuit 119 receives a command from the memory controller 120. The control logic circuit 119 may decode the received command CMD and control the overall operation of the nonvolatile memory 110 according to the decoded command. The control logic circuit 119 may further receive various control signals and voltages from the memory controller 120.

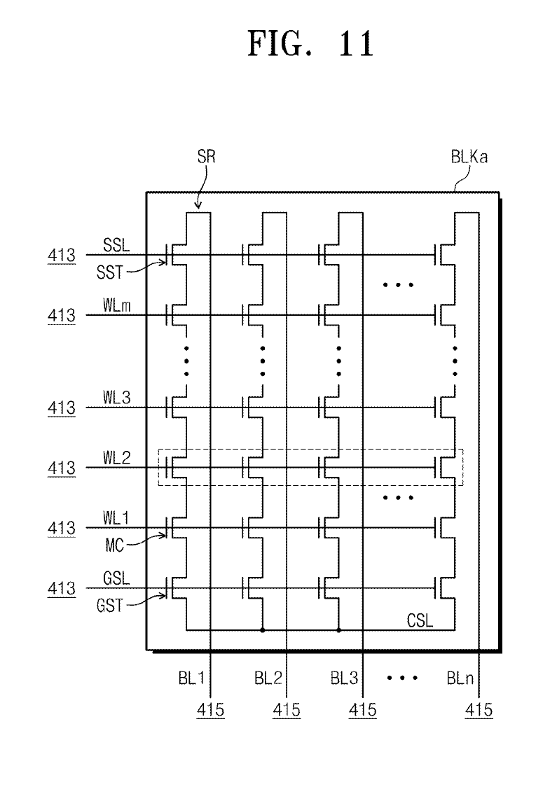

FIG. 11 is a circuit diagram of a memory block BLKa according to an embodiment of the inventive concept. Among the memory blocks BLK1 to BLKz of the memory cell array 111 in FIG. 10, one memory block BLKa is exemplarily shown in FIG. 11.

Referring to FIGS. 10 and 11, the memory block BLKa includes a plurality of strings SR. The strings SR may be connected to a plurality of bitlines BL1 to BLn, respectively. Each of the strings SR includes a ground selection transistor GST, memory cells MC, and a string selection transistor SST.

The ground selection transistor GST of each string SR is coupled between memory cells MC and a common source line CSL. The ground selection transistors GST of the strings SR are commonly connected to the common source line GSL.

A string selection transistor SST of each string SR is coupled between memory cells MC and a bitline BL. String selection transistors SST of the strings SR are connected to the bitlines BL1 to BLn, respectively. The bitlines BL1 to BLn may be connected to the page buffer circuit 115.

In each string SR, a plurality of memory cells MC are provided between a ground selection transistor GST and a string selection transistor SST. In each string SR, a plurality of memory cells MC may be connected in series.

In the strings SR, memory cells disposed in the same order from a common source line CSL may be commonly connected to a single wordline. Memory cells MC of the strings SR may be connected to a plurality of wordlines WL1 to WLm. The wordlines WL1 to WLm may be connected to the address decoder circuit 113.

A single memory cell MC may store a single bit or two or more bits.

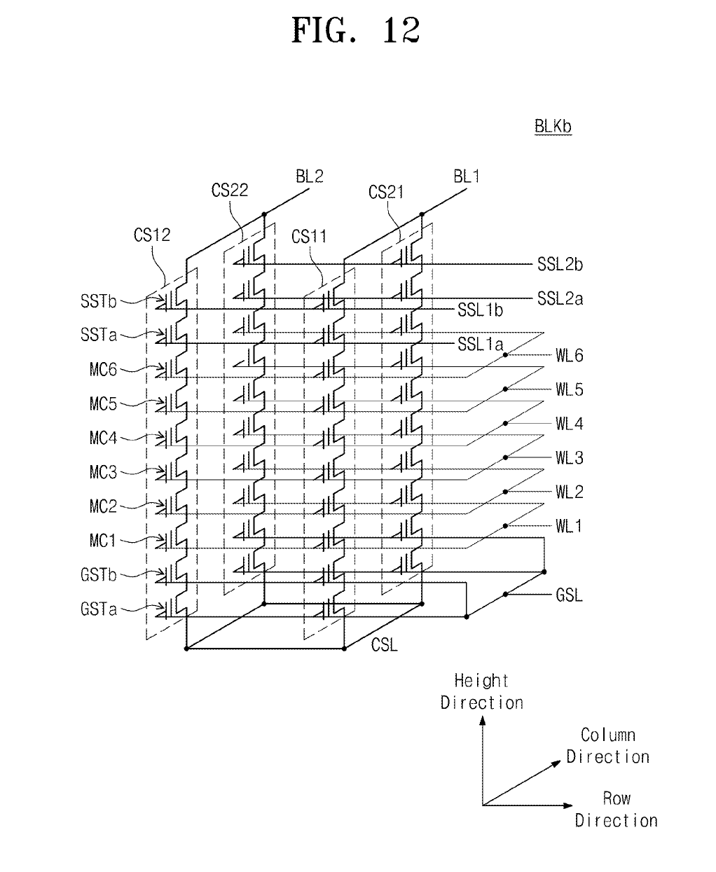

FIG. 12 is a circuit diagram of a memory block BLKb according to another embodiment of the inventive concept. As illustrated, the memory block BLKb includes a plurality of cell strings CS11 to CS21 and CS12 to CS22. The cell strings CS11 to CS21 and CS12 to CS22 may be arranged in a row direction and a column direction to form rows and columns.

For example, cell strings CS11 and CS12 arranged in the row direction may form a first row and cell strings CS21 and CS22 arranged in the row direction may form a second row. Cell strings CS11 and CS21 arranged in the column direction may form a first column and cell strings CS12 and CS22 arranged in the column direction may form a second column.

Each of the cell strings CS11 to CS21 and CS12 to CS22 may include a plurality of cell transistors. The cell transistors include ground selection transistors GSTa and GSTb, memory cells MC1 to MC6, and string selection transistors SSTa and SSTb. Ground selection transistors GSTa and GSTb, memory cells MC1 to MC6, and string selection transistors SSTa and SSTb of each cell string may be stacked in a height direction perpendicular to a plane on which the cell strings CS11 to CS21 and CS12 to CS22 are arranged along rows and columns (e.g., a plane on a substrate of the memory block BLKb).

Lowermost ground selection transistor GSTa may be commonly connected to a common source line CSL.

The ground selection transistors GSTa and GSTb of the cell strings CS11 to CS21 and CS12 to CS22 may be commonly connected to a ground selection line GSL.

In some embodiments, ground selection transistors of the same height (or order) may be connected to the same ground selection line, and ground selection transistors of different heights (or orders) may be connected to different ground selection lines. For example, ground selection transistors of first height may be commonly connected to a first ground selection line, and ground selection transistors of second height may be commonly connected to a second ground selection line.

In some embodiments, ground selection transistors of the same row may be connected to the same ground selection line, and ground selection transistors of different rows may be connected to different ground selection lines. For example, ground selection transistors GSTa and GSTb of cell strings CS11 and CS12 of a first row may be connected to a first ground selection line, and ground selection transistors GSTa and GSTb of cell strings CS21 and CS22 of a second row may be connected to a second ground selection line.

Memory cells disposed at the same height (or order) from a substrate (or ground selection transistors GST) may be commonly connected to a single wordline, and memory cells disposed at different heights (or orders) from the substrate (or the ground selection transistors GST) may be connected to different wordlines WL1 to WL6, respectively. For example, memory cells MC1 are commonly connected to the wordline WL1. Memory cells MC2 are commonly connected to the wordline WL2. Memory cells MC3 are commonly connected to the wordline WL3. Memory cells MC4 are commonly connected to the wordline WL4. Memory cells MC5 are commonly connected to the wordline WL5. Memory cells MC6 are commonly connected to the wordline WL6.

In first string selection transistors SSTa of the same height (or order) of the cell strings CS11 to CS21 and CS12 to CS22, first string selection transistors SSTa of different rows are connected to different string selection lines SSL1a to SSL2a, respectively. For example, first string selection transistors SSTa of the cell strings CS11 and CS12 are commonly connected to the string selection line SSL1a. First string selection transistors SSTa of the cell strings CS21 and CS22 are commonly connected to the string selection line SSL2a.

In second string selection transistors SSTb of the same height (or order) of the cell strings CS11 to CS21 and CS12 to CS22, second string selection transistors SSTb of different rows are connected to different string selection lines SSL1b to SSL2b, respectively. For example, second string selection transistors SSTb of the cell strings CS11 and CS12 are commonly connected to the string selection line SSL1b. Second string selection transistors SSTb of the cell strings CS21 and CS22 are commonly connected to the string selection line SSL2b.

That is, cell strings of different rows are connected to different string selection lines. String selection transistors of the same height (or order) of cell strings of the same row are connected to the same string selection line. String selection transistors of different heights (or orders) of cell strings of the same row are connected to different string selection lines.

In some embodiments, string selection transistors of cell strings of the same row may be commonly connected to a single string selection line. For example, string selection transistors SSTa and SSTb of the cell strings CS11 and CS12 of a first row may be commonly connected to a single string selection line. String selection transistors SSTa and SSTb of the cell strings CST21 and CS22 of a second row may be commonly connected to a single string selection line.

Columns of the cell strings CS11 to CS21 and CS12 to CS22 are connected to different bitlines BL1 and BL2, respectively. For example, string selection transistors SSTb of the cell strings CS11 to CS21 of a first column are commonly connected to a bitline BL1. String selection transistors SST of the cell strings CS12 to CS22 of a second column are commonly connected to a bitline BL2.

The memory block BLKb shown in FIG. 12 is exemplary. The invention concept is not limited to the memory block BLKb shown in FIG. 12. For example, the number of rows of cell strings may increase or decrease. As the number of the rows of the cell strings varies, the number of string selection lines or ground selection lines connected to the rows of the cell strings and the number of cell strings connected to a single bitline may also vary.

The number of columns of cell strings may increase or decrease. As the number of the columns of the cell strings varies, the number of bitlines connected to the columns of the cell strings and the number of cell strings connected to a single string selection line may also vary.

Height of cells strings may increase or decrease. For example, the number of ground selection transistors, memory cells or string selection transistors respectively stacked on the cell strings may increase or decrease.

In some embodiments, a read operation and a write operation may be performed in units of rows of the cell strings CS11 to CS21 and CS12 to CS22. The cell strings CS11 to CS21 and CS12 to CS22 may be selected in unit of a single row by the string selection lines SSL1a, SSL1b, SSL2a, and SSL2b.

A write operation and a read operation may be performed in units of wordlines at the selected row of the cell strings CS11 to CS21 and CS12 to CS22. Memory cells connected to a selected wordline may be programmed at the selected row of the cell strings CS11 to CS21 and CS12 to CS22.

In an embodiment of the present inventive concept, a three dimensional (3D) memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In an embodiment of the present inventive concept, the 3D memory array includes vertical NAND strings that are vertically oriented such that at least one memory cell is located over another memory cell. The at least one memory cell may comprise a charge trap layer. Each vertical NAND string further includes at least one select transistor located over memory cells, the at least one select transistor having the same structure with the memory cells and being formed monolithically together with the memory cells.

The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

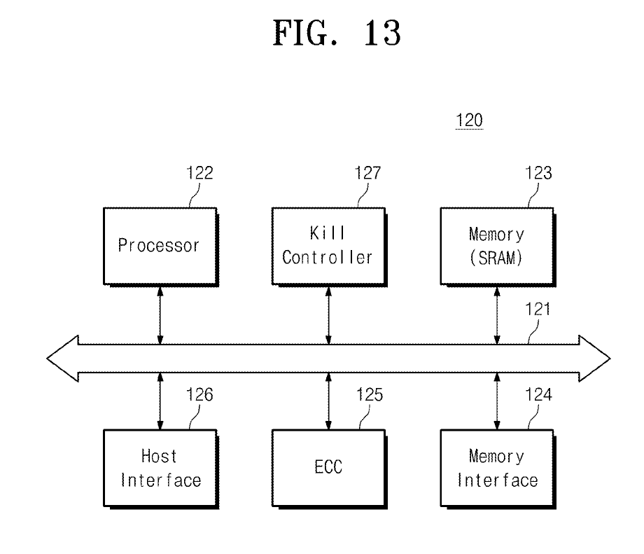

FIG. 13 is a block diagram of a memory controller 120 according to an embodiment of the inventive concept. As illustrated, the memory controller 120 includes a bus 121, a processor 122, a memory 123, a memory interface 124, an error correction block (ECC) 125, a host interface 126, and a kill controller 127.

The bus 121 is configured to provide a channel between components of the memory controller 120.

The processor 122 may control the overall operation of the memory controller 120 and perform a logical operation. The processor 122 may communicate with an external host through the host interface 130. The processor 122 may communicate with an external nonvolatile memory 110 (see FIG. 10) through the memory interface 124. The processor 122 may include a microcontroller.

The memory 123 may be used as a working memory, a cache memory or a buffer memory of the processor 122. The memory 123 may store codes and commands executed by the processor 122. The memory 123 may store data processed by the processor 122. The memory 123 may include an SRAM.

The memory interface 124 may communicate with the nonvolatile memory 110 according to the control of the processor 122.

The ECC 125 may perform error correction. The ECC 125 may generate a parity to perform error correction, based on data to be written into the nonvolatile memory 110. The data and the parity may be transmitted to the nonvolatile memory 110 through the memory interface 124 and may be written into the nonvolatile memory 110. The ECC 125 may correct an error of data using the data and the parity read from the nonvolatile memory 110 through the memory interface 124.

The host interface 126 may communicate with an external host according to the control of the processor 122. The host interface 126 may perform communication based on at least one of various communication protocols such as SATA (Serial AT Attachment), eSATA, PCI (Peripheral Component Interconnect), PCI-e, SCSI (Small Computer System Interface), USB (Universal Serial Bus), Mini USB, Micro USB, Firewire, and NVMe.

The kill controller 127 may control the memory controller 120 to perform a kill function in response to a kill request. For example, the kill controller 127 may control the memory controller 120 such that the memory controller 120 enters a locked mode or a destruction mode. The kill controller 127 may be implemented using hardware or software driven in the processor 122.

In some embodiments, the memory controller 120 may further include an encoding module to encode data written into the nonvolatile memory 110 and a decoding module to decode data read from the nonvolatile memory 110.

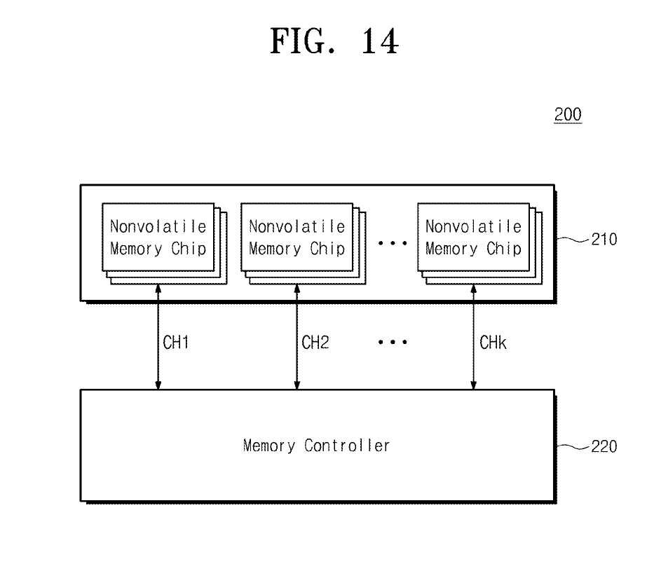

FIG. 14 is a block diagram of a storage 200 according to another embodiment of the inventive concept. As illustrated, the storage 200 includes a nonvolatile memory 210 and a memory controller 220. The nonvolatile memory 210 includes a plurality of memory chips. The memory chips are divided into a plurality of groups. Each group of the nonvolatile memory chips is configured to communicate with the memory controller 220 through a single common channel. As exemplarily shown in FIG. 14, a plurality of nonvolatile memory chips communicate with the memory controller 220 through first to kth channels CH1 to CHk.

In FIG. 14, it is described that a plurality of nonvolatile memory chips are connected to a single channel. However, the storage 200 may be changed such that a single nonvolatile memory chip is connected to a single channel.

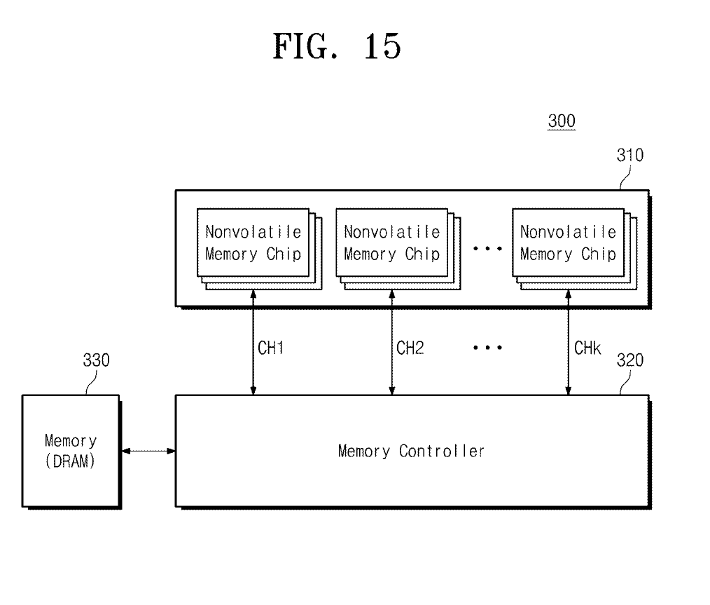

FIG. 15 is a block diagram of a storage 300 according to another embodiment of the inventive concept. As illustrated, the storage 300 includes a nonvolatile memory 310, a memory controller 320, and a memory 330. As compared to the storage 200 described with reference to FIG. 14, the storage 300 further includes the memory 330.

The memory 330 may be a buffer memory of the storage 300. For example, the memory controller 320 may temporarily store data received from an external host in the memory 330. The data stored in the memory 330 may be written into the nonvolatile memory 330. The memory controller 320 may temporarily store data read from the nonvolatile memory 310. The data stored in the memory 330 may be output to an external host or rewritten into the nonvolatile memory 310. The memory 330 may include a DRAM.

In some embodiments, storages according to embodiments of the inventive concept may constitute a solid-state drive (SSD).

Storages according to embodiments of the inventive concept may constitute a storage module such as a memory card or an embedded memory. For example, storages according to embodiments of the inventive concept may constitute a various storage modules such as a solid-state drive (SSD), a person computer memory card international association (PCMCIA) card, a compact flash card (CF), smart media cards (SM and SMC), a memory stick, multimedia cards (MMC, RS-MMC, and MMCmicro), SD cards (SD, miniSD, microSD,k and SDHC), a universal flash storage (UFS) module, and an embedded MMC (eMMC) module.

If a kill function is supported to a memory card or an SSD, data leakage may be prevented when the memory card or the SSD is lost.

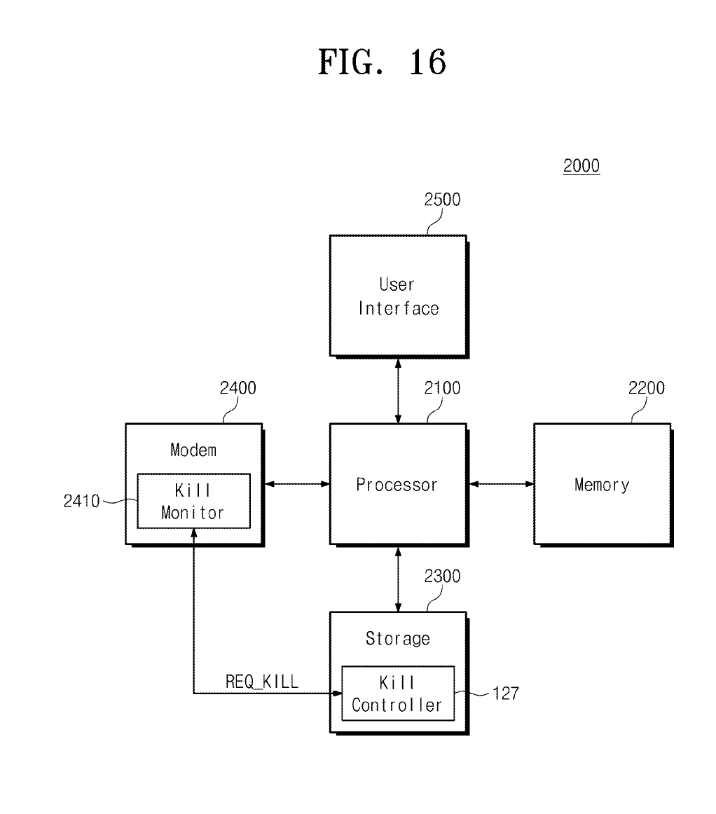

FIG. 16 is a block diagram of a mobile device 2000 according to another embodiment of the inventive concept. As illustrated, the mobile device 2000 includes a processor 2100, a memory 2200, a storage 2300, a modem 2400, and a user interface 2500.

As compared to the mobile device 1000 in FIG. 2, the modem 2400 of the mobile device 2000 includes a kill monitor 2410. The kill monitor 2410 may monitor whether a kill message MSG_KILL is received through a network 10 (see FIG. 1). When the kill message MSG_KILL is received, the kill monitor 2410 may transmit a kill request REQ_KILL to the storage 2300.

According to this embodiment, the kill request REQ_KILL is transmitted to the storage 2300 without passing through the processor 2100 of the mobile device 2000. Thus, performance of an anti-hacking function provided by the kill function may be further enhanced.

According to embodiments of the inventive concept, a kill function is supported in a storage device constituting a storage module. Thus, a method of operating a nonvolatile memory with improved security and a memory controller is provided.

While the present disclosure has been particularly shown and described with reference to exemplary embodiments thereof, it will be understood by those of ordinary skill in the art that various changes in form and details may be made therein without departing from the spirit and scope of the present disclosure as defined by the following claims. For example, it is possible to adjust the driving capability of a sub word line driver or adjust the slope of level of applied driving signals by changing, adding, or removing the circuit configuration or arrangement in the drawings without departing from the technical spirit of the present disclosure in other cases.

What is claimed is:

1. A method of operating a storage device including a nonvolatile memory and a memory controller configured to control the nonvolatile memory, the method comprising:
receiving a kill request by the memory controller;
performing authentication based on the received kill request by the memory controller; and
entering a locked state, by the memory controller, according to the kill request when the authentication is successfully performed,
wherein the memory controller denies a request for access to a selected area of the nonvolatile memory in the locked state.

2. The method as set forth in claim 1, wherein the selected area includes a whole area of the nonvolatile memory.

3. The method as set forth in claim 1, wherein the selected area includes a partial area of a whole area of the nonvolatile memory.

4. The method as set forth in claim 1, wherein the selected area includes a whole area of the nonvolatile memory when the received kill request is a first type, and
wherein the selected area includes a partial area of the whole area of the nonvolatile memory when the received kill request is a second type.

5. The method as set forth in claim 1, further comprising:
receiving a revive request by the memory controller;
performing second authentication based on the received revive request by the memory controller; and
entering a normal state, by the memory controller, according to the revive request when the second authentication is successfully performed,
wherein the memory controller allows a request for access to the nonvolatile memory in the normal state.

6. The method as set forth in claim 1, wherein the nonvolatile memory and the memory controller constitute an embedded storage module.

7. The method as set forth in claim 1, wherein the nonvolatile memory and the memory controller constitute a solid-state drive (SSD).

8. The method as set forth in claim 1, wherein the nonvolatile memory and the memory controller constitute a storage module of a mobile device.

9. A method of operating a storage device including a nonvolatile memory and a memory controller configured to control the nonvolatile memory, the method comprising:
receiving a kill request by the memory controller;
performing authentication based on the received kill request by the memory controller; and
destroying data in a selected area among data stored in the nonvolatile memory, by the memory controller, according to the kill request when the authentication is successfully performed.

10. The method as set forth in claim 9, wherein the data in the selected area is erased when the memory controller destroys the data in the selected area.

11. The method as set forth in claim 9, wherein the data in the selected data is overwritten as predetermined pattern data or random pattern data when the memory controller destroys the data in the selected area.

12. The method as set forth in claim 9, wherein a key data used to encode or decode the data in the selected area is erased when the memory controller destroys the data in the selected area.

13. The method as set forth in claim 9, wherein the selected area includes a whole area of the nonvolatile memory.

14. The method as set forth in claim 9, wherein the selected area includes a partial area among a whole area of the nonvolatile memory.

15. The method as set forth in claim 9, wherein the selected area includes a whole area of the nonvolatile memory when the received kill request is a first type, and
wherein the selected area includes a partial area of the whole area of the nonvolatile memory when the received kill request is a second type.

16. The method as set forth in claim 9, further comprising:
entering a locked state, by the memory controller, after destroying the data in the selected area,
wherein the memory controller denies a request for access to the nonvolatile memory in the locked state.

17. The method as set forth in claim 9, further comprising:
receiving a revive request by the memory controller;
performing second authentication based on the received revive request by the memory controller; and
entering a normal state, by the memory controller, according to the revive request when the second authentication is successfully performed,
wherein the memory controller allows a request for access to the nonvolatile memory in the normal state.

18. A method of operating device including a nonvolatile memory and a memory controller configured to control the nonvolatile memory, the method comprising:
receiving a kill request by the memory controller;
performing authentication based on the received kill request by the memory controller;
entering a locked mode, by the memory controller, when the authentication is successful and the received kill request is a first type; and
entering a destruction mode, by the memory controller, when the authentication is successful and the received kill request is a second type,
wherein the memory controller denies a request for access to a selected area of the nonvolatile memory in the locked mode,
wherein the memory controller destroys data in the selected area among data stored in the nonvolatile memory in the destruction mode.

19. The method as set forth in claim 18, further comprising:
entering the locked mode, by the memory controller, after destroying the data in the destruction mode.

20. The method as set forth in claim 18, wherein the selected area is a whole area of the nonvolatile memory when the received kill request is a global request,
wherein the selected area is a partial area of the whole area of the nonvolatile memory when the received kill request is a partial request.
